(19) United States
(12) Patent Application Publication
(10) Pub. No.: US 2007/0071041 A1
(43) Pub. Date: Mar. 29, 2007

(54) Laser oscillation device

(75) Inventors: Taizo Eno, Itabashi-ku (JP); Masayuki Momiuchi, Itabashi-ku (JP); Yoshiaki Goto, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/483,952

(22) Filed: Jul. 10, 2006

(30) Foreign Application Priority Data
Sep. 15, 2005 (JP) 2005-268845

(51) Int. Cl. H01S 3/10

(52) U.S. Cl. 372/21

(57) ABSTRACT

A laser oscillation device, comprising optical crystals, wherein a metal or metal family film is formed over the entire surface of the optical crystals at least except openings where excitation lights enter.

The present invention relates to a laser oscillation device using a semiconductor laser as an excitation source.

First, description will be given on general features of a laser oscillation device 1.

FIG. 7 shows an example of the laser oscillation device 1. A diode-pumped solid-state laser of one-wavelength oscillation is shown.

In FIG. 7, reference numeral 2 denotes a light emitting unit, and numeral 3 denotes an optical resonator. The light emitting unit 2 comprises an LD light emitter 4 and a condenser lens 5. Further, the optical resonator 3 comprises a first optical crystal (laser crystal 8) with a first dielectric reflection film 7 formed on the first optical crystal, a second optical crystal (nonlinear optical crystal (NLO) (wavelength conversion crystal 9)), and a concave mirror 12 with a second dielectric reflection film 11 formed on the concave mirror 12. At the optical resonator 3, the laser beam is pumped, resonated, amplified, and outputted. As the laser crystal 8, Nd:YVO₄ is used. As the wavelength conversion crystal 9, KTP (KTiOPO₄; potassium titanyl phosphate) is used.

Further, detailed description will be given below.

The laser oscillation device 1 is used to emit a laser beam with a wavelength of 809 nm, for instance, and the LD light emitter 4, i.e. a semiconductor laser, is used. The LD light emitter 4 fulfills a function as a pumping light generator to generate an excitation light. The laser oscillation device 1 is not limited to the semiconductor laser, and any type of light source means can be adopted so far as it can generate a laser beam.

The laser crystal 8 is used to amplify the light. As the laser crystal 8, Nd:YVO₄ with an oscillation line of 1064 nm is used. Further, YAG (yttrium aluminum garnet) doped with Nd³⁺ ions, etc. are adopted. YAG has oscillation lines of 946 nm, 1064 nm, 1319 nm, etc. Also, Ti (Sapphire) with an oscillation line of 700 nm to 900 nm, etc. may be used as the laser crystal 8.

On a surface of the laser crystal 8 closer to the LD light emitter 4, the first dielectric reflection film 7 is formed. The first dielectric reflection film 7 is highly transmissive to the laser beam from the LD light emitter 4, and the first dielectric reflection film 7 is highly reflective to an oscillation wavelength of the laser crystal 8. The first dielectric reflection film 7 is also highly reflective to the secondary higher harmonic wave (SHG: Second Harmonic Generation).

The concave mirror 12 is arranged to face toward the laser crystal 8. A side of the concave mirror 12 closer to the laser crystal 8 is fabricated in form of a mirror with a concave spherical surface having an adequate radius, and the second dielectric reflection film 11 is formed on the surface of the concave mirror 12. The second dielectric reflection film 11 is highly reflective to the oscillation wavelength of the laser crystal 8, and the second dielectric reflection film 11 is highly transmissive to the secondary higher harmonic wave.

As described above, the first dielectric reflection film 7 of the laser crystal 8 is combined with the second dielectric reflection film 11 of the concave mirror 12, and the laser beam from the LD light emitter 4 is pumped to the laser crystal 8 through the condenser lens 5. As a result, the light reciprocates between the first dielectric reflection film 7 of the laser crystal 8 and the second dielectric reflection film 11, and the light can be confined for long time. Therefore, the light can be resonated and amplified.

The wavelength conversion crystal 9 is placed within the optical resonator, which comprises the first dielectric reflection film 7 of the laser crystal 8 and the concave mirror 12. When a strong coherent light such as a laser beam enters the wavelength conversion crystal 9, a secondary higher harmonic wave to double a frequency of light is generated. The generation of the secondary higher harmonic wave is called “Second Harmonic Generation”. Therefore, a laser beam with a wavelength of 532 nm is emitted from the laser oscillation device 1.

In the laser oscillation device 1 as described, the wavelength conversion crystal 9 is disposed within the optical resonator, which comprises the laser crystal 8 and the concave mirror 12. This is called an intracavity type SHG. Because a conversion output is proportional to a square of the excitation light photoelectric power, high light intensity in the optical resonator can be directly utilized.

In general, a semiconductor laser does not emit a laser beam of high output. Therefore, the diode-pumped solid-state laser, using the laser beam from the LD light emitter 4 as an excitation light, does not provide high output. However, to fulfill the demand on higher output in recent years, a semiconductor laser is now known, which has the LD light emitter 4 with a plurality of semiconductor lasers 13.

For instance, in the laser oscillation device described in the Japanese Patent Application Publication No. 2003-124553, the LD light emitter 4 comprises a plurality of semiconductor lasers 13 as shown in FIG. 8. The plurality of semiconductor lasers 13 are arranged in form of an array. The laser beams emitted from the semiconductor lasers 13 are respectively converged to corresponding optical fibers 15, via a rod lens 14, and the optical fibers 15 are bundled together to a fiber cable 16. The laser beams bundled together are turned to an excitation light 17 with high light intensity, and the high intensity light is entered to the laser crystal 8 to achieve higher output.

When the excitation light 17 is entered to the laser crystal 8, the excitation light 17 is absorbed by the laser crystal 8, excitation and oscillation occur on an end surface of the laser crystal 8, and a part of the energy of the excitation light 17 not absorbed is turned to heat. For this reason, temperature rises at the highest on the incident end surface of the laser crystal 8 in the laser oscillation device of end surface excitation type. The heat not radiated is accumulated within the laser crystal 8, and the temperature of the laser crystal 8 rises.

When light intensity of the excitation light entering the laser crystal 8, i.e. energy density of excitation, is increased, temperature of the laser crystal 8—in particular, the temperature on the incident end surface—rises locally. In addition, because the laser crystal 8 itself has low thermal conductivity, optical and mechanical distortion occurs, and laser oscillation may not be carried out. Further, if the distortion is increased, the crystal may be destroyed.

To cope with the temperature rise of the laser crystal 8 and of the wavelength conversion crystal 9 caused by the increase of light intensity of the excitation light, it is practiced to cool down the laser crystal 8 and the wavelength conversion crystal 9. In the Japanese Patent Application Publication No. 2003-124553, a cooling structure as shown in FIG. 9 is described. In FIG. 9, the equivalent component as shown in FIG. 7 or in FIG. 8 is referred by the same symbol.

The light emitting unit 2 and the optical resonator 3 are fixed on a base 19, which serves as a heat sink. The light emitting unit 2 and the optical resonator 3 are arranged on an optical axis 10 (see FIG. 7), and a lens unit 21 including the condenser lens 5 is disposed between the light emitting unit 2 and the optical resonator 3.

An optical resonator block 22 is fixed on the base 19. The optical resonator block 22 comprises the laser crystal 8 on the optical axis 10, and the concave mirror 12 is arranged on a side of the optical resonator block 22 opposite side to the lens unit 21.

A recess 23 is formed in the optical resonator block 22 from above, and the wavelength conversion crystal 9 held by a wavelength conversion crystal holder 24 is accommodated in the recess 23. The wavelength conversion crystal holder 24 is tiltably mounted on the optical resonator block 22 via a spherical seat 25 so that an optical axis of the wavelength conversion crystal holder 24 can be aligned with the optical axis 10. Also, on the optical resonator block 22, a Peltier element 26 is provided to cool down the wavelength conversion crystal 9.

It is composed in such manner that the heat of the laser crystal 8 is radiated from the base 19 via the optical resonator block 22, and the wavelength conversion crystal 9 is cooled down by the Peltier element 26.

The cooling of the laser crystal 8 is attained by heat conduction, from the laser crystal 8 to the optical resonator block 22, and further, from the optical resonator block 22 to the base 19. The laser crystal 8 itself has poor thermal conductivity and low mechanical strength. For this reason, in order to increase thermal conductivity from the laser crystal 8 to the optical resonator block 22, it is proposed to promote close fitting between the laser crystal 8 and the optical resonator block 22 via soft metal such as indium, etc.

However, the highest temperature rise of the laser crystal 8 occurs on the end surface where the excitation light 17 enters. The excitation light 17 has high energy and high energy density. Moreover, the laser crystal 8 itself has low thermal conductivity, therefore, heat input amount at the incident point of the excitation light 17 on the laser crystal 8 is larger compared with heat transfer amount caused by heat conduction. For this reason, by the cooling operation based on heat conduction from the laser crystal 8 to the optical resonator block 22, it is difficult to suppress temperature rise on the end surface of the laser crystal 8. The temperature at the incident point rises to high temperature, and steep temperature gradient is caused between the incident point and its surrounding region.

Therefore, in the cooling system in the past based on heat conduction from the laser crystal 8 to the optical resonator block 22, it is difficult to perform sufficient cooling of the laser crystal 8, in particular the incident end surface on the laser crystal 8.

In recent years, there have been trends to design the laser oscillation device 1 in smaller size and to design laser oscillation to tips. It is now practiced to integrate the laser crystal 8 and the wavelength conversion crystal 9 with each other by using adhesive agent. FIG. 10 shows a case where the laser crystal 8 and the wavelength conversion crystal 9 are integrated with each other. The first dielectric reflection film 7 is formed on an incident end surface of the laser crystal 8 and the second dielectric reflection film 11 is formed on an exit end surface of the wavelength conversion crystal 9, and the optical resonator 3 is made up from the first dielectric reflection film 7 and the second dielectric reflection film 11.

When the laser crystal 8 and the wavelength conversion crystal 9 are integrated with each other, heat cannot be radiated from the exit end surface of the laser crystal 8. Because thermal conductivity of the laser crystal 8 is low, the amount of the heat radiated via the wavelength conversion crystal 9 is small. As a result, the accumulation of heat to the laser crystal 8 is increased further, and this is against the satisfaction of the demands to have the laser beam with higher output.

Also, it is composed in such manner that a part of the secondary higher harmonic waves generated at the optical resonator 3 is reflected by the first dielectric reflection film 7 and is emitted from the optical resonator 3. Because the secondary higher harmonic waves pass through the laser crystal 8 during the process of reflection from the first dielectric reflection film 7, the phase of the secondary higher harmonic waves is deviated, and the secondary higher harmonic waves 20 emitted from the optical resonator 3 are turned to elliptically polarized lights.

### SUMMARY OF THE INVENTION

It is an object of the present invention to provide a laser oscillation device, by which it is possible to effectively cool down the optical crystals such as the laser crystal and the wavelength conversion crystal, etc. and to prevent the deviation of the phase of polarizing light of the generated secondary higher harmonic waves.

To attain the above object, the laser oscillation device according to the present invention comprises optical crystals, wherein a metal or metal family film is formed over the entire surface of the optical crystals at least except openings where excitation lights enter. Also, the present invention provides the laser oscillation device as described above, wherein the optical crystals comprise a laser crystal for converting an excitation light to a fundamental wave and a wavelength conversion crystal for converting a fundamental wave to a secondary higher harmonic wave, the metal or metal family film is formed on the two crystals except openings where the excitation light, the fundamental wave, and the secondary higher harmonic wave pass through, and the laser crystal and the wavelength conversion crystal are soldered together via the metal or metal family film or are bonded together by metal diffusion. Further, the present invention provides the laser oscillation device as described above, wherein the optical crystals comprise a laser crystal for converting an excitation light to a fundamental wave and a wavelength conversion crystal for converting a fundamental wave to a secondary higher harmonic wave, the metal or metal family film is formed on the two crystals except openings where the excitation light, the fundamental wave, and the secondary higher harmonic wave pass through, and the laser crystal and the wavelength conversion crystal are bonded together by metal diffusion via the metal or metal family film. Also, the present invention provides the laser oscillation device as described above, wherein a first dielectric reflection film is formed on an incident surface of the laser crystal and a third dielectric reflection film is formed on an exit surface of the laser crystal, a fourth dielectric reflection film is formed on an incident end surface of the wavelength conversion crystal and a second dielectric reflection film is formed on an exit surface of the wavelength conversion crystal, and the third dielectric reflection film and the fourth dielectric reflection film are kept in optically non-contact condition from each other. Further, the present invention provides the laser oscillation device as described above, wherein the metal or metal family film is interposed between the third dielectric reflection film and the fourth dielectric reflection film, and the third dielectric reflection film and the fourth dielectric reflection film are kept in optically non-contact condition from each other. Also, the present invention provides the laser oscillation device as described above, wherein the first dielectric reflection film is highly transmissive to the excitation light and is highly reflective to the fundamental wave, the second dielectric reflection film is highly reflective to the fundamental wave and is highly transmissive to the secondary higher harmonic wave, and one of either the third dielectric reflection film or the fourth dielectric reflection film is highly reflective to the secondary higher harmonic wave. Further, the present invention provides the laser oscillation device as described above, wherein the optical crystals are soldered to a heat radiation member via the metal or metal family film. Also, the present invention provides the laser oscillation device as described above, wherein the optical crystals are bonded to a heat radiation member via the metal or metal family film by metal diffusion.

According to the present invention, a laser oscillation device comprises optical crystals, wherein a metal or metal family film is formed over the entire surface of the optical crystals at least except openings where excitation lights enter. As a result, the heat generated at the optical crystals is efficiently diffused to the surrounding via the metal or metal family films, and temperature rise on the optical crystals can be suppressed.

Also, according to the present invention, the optical crystals comprise a laser crystal for converting an excitation light to a fundamental wave and a wavelength conversion crystal for converting a fundamental wave to a secondary higher harmonic wave, the metal or metal family film is formed on the two crystals except openings where the excitation light, the fundamental wave, and the secondary higher harmonic wave pass through, and the laser crystal and the wavelength conversion crystal are soldered together via the metal or metal family film or are bonded together by metal diffusion. This facilitates the heat transfer between the laser crystal and the wavelength conversion crystal, and the heat can be radiated via the metal or metal family films from the entire surfaces of the laser crystal and the wavelength conversion crystal. This provides high heat radiation effects, and the heat can be efficiently diffused to the surrounding and temperature rise on the optical crystals can be suppressed.

Also, according to the present invention, a first dielectric reflection film is formed on an incident surface of the laser crystal and a third dielectric reflection film is formed on an exit surface of the laser crystal, a fourth dielectric reflection film is formed on an incident end surface of the wavelength conversion crystal and a second dielectric reflection film is formed on an exit surface of the wavelength conversion crystal, and the third dielectric reflection film and the fourth dielectric reflection film are kept in optically non-contact condition from each other. This facilitates the preparation of the third dielectric reflection film and the fourth dielectric reflection film.

Also, according to the present invention, the first dielectric reflection film is highly transmissive to the excitation light and is highly reflective to the fundamental wave, the second dielectric reflection film is highly reflective to the fundamental wave and is highly transmissive to the secondary higher harmonic wave, and one of either the third dielectric reflection film or the fourth dielectric reflection film is highly reflective to the secondary higher harmonic wave. As a result, the secondary higher harmonic waves do not pass through the laser crystal, and the deviation of the phase of the polarizing light can be eliminated.

Also, according to the present invention, the optical crystals are soldered to a heat radiation member via the metal or metal family film. As a result, the heat diffused to the metal or metal family films is thermally conducted to the heat radiation member, and thermal resistance between the optical crystals and the heat radiation member is low. Thus, the heat can be effectively radiated from the heat radiation member.

### BRIEF DESCRIPTION OF THE DRAWINGS

FIG. 1 is a schematical drawing to show an essential portion of a first embodiment of the present invention;

FIG. 2 is a schematical drawing to explain how wavelength is converted in the first embodiment of the present invention;

FIG. 3 is a schematical plan view of a laser device using a laser oscillation device of the present invention;

FIG. 4 is a schematical side view of a laser device using a laser oscillation device of the present invention;

FIG. 5 is a perspective view of an optical resonator in the laser device;

FIG. 6 is a drawing to explain when a plurality of laser beams emitted from the optical resonator are monitored;

FIG. 7 is a schematical drawing of the laser oscillation device of the present invention;

FIG. 8 is a schematical drawing when a light emitting unit of the laser oscillation device has a plurality of semiconductor lasers;

FIG. 9 is a cross-sectional view of a conventional type laser oscillation device; and

FIG. 10 is a schematical drawing to show a case where a laser crystal and a wavelength conversion crystal of the laser oscillation device are integrated with each other.

### DETAILED DESCRIPTION OF THE PREFERRED EMBODIMENT

Description will be given below on the best mode of the present invention referring to the drawings.

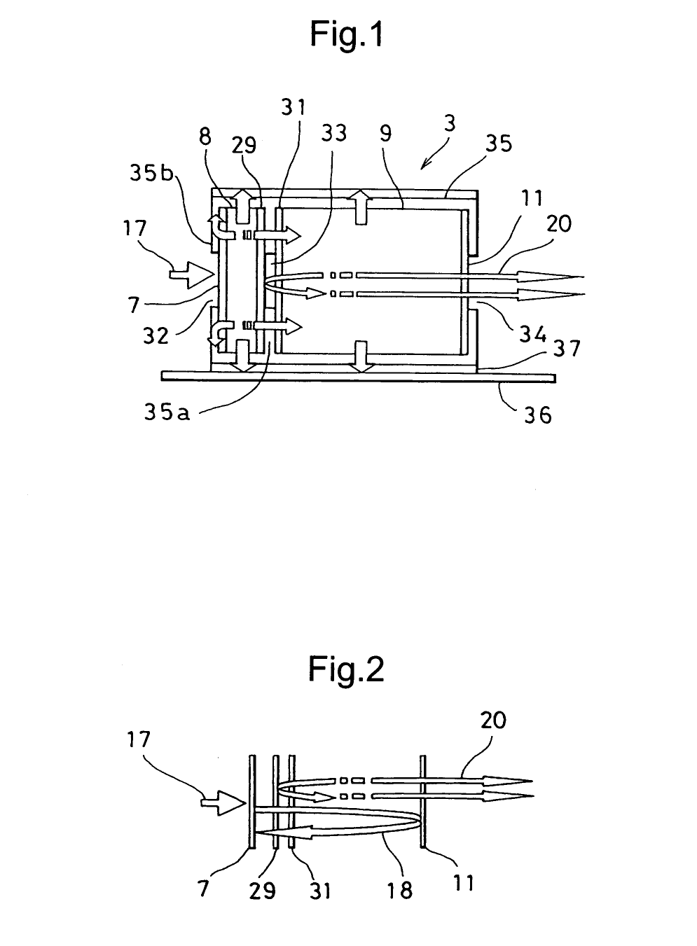

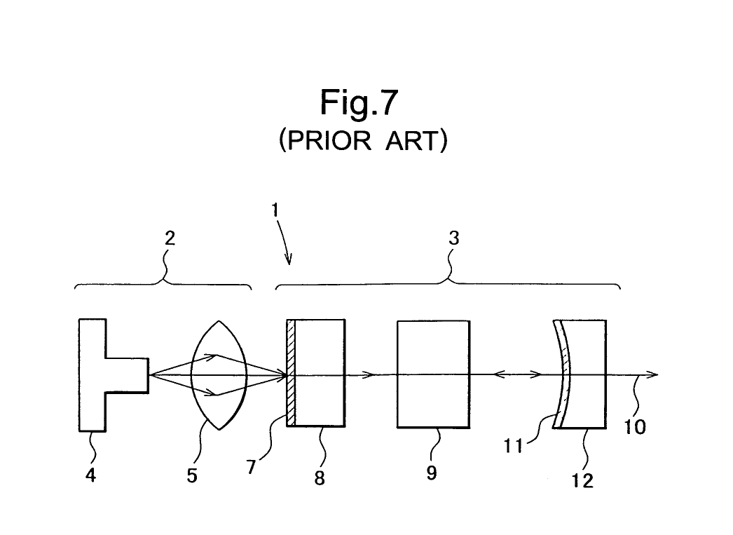

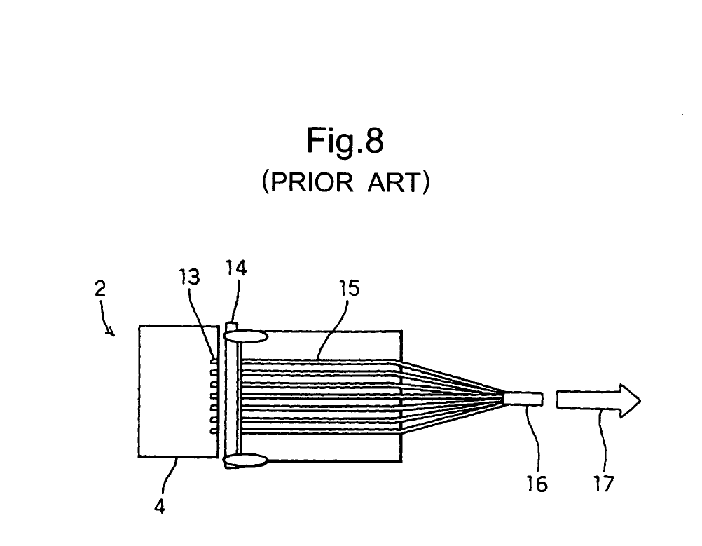

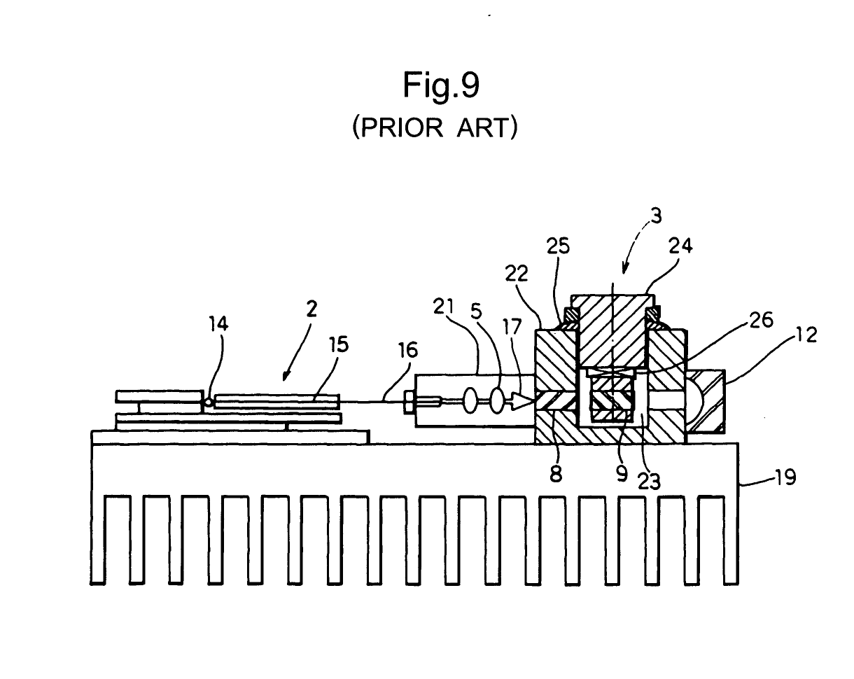

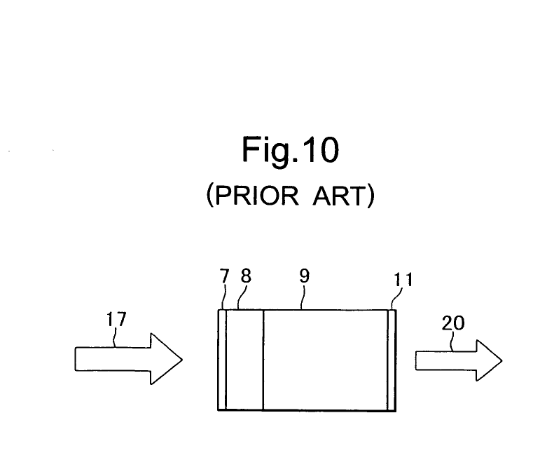

Now, general features of a first embodiment of the present invention will be described below referring to FIG. 1. In FIG. 1, a light emitting unit is not shown, and the equivalent component as shown in FIG. 7 is referred by the same symbol.

On an incident end surface of a laser crystal 8 such as Nd:YVO₄, a first dielectric reflection film 7 is formed, which is highly transmissive to an excitation light 17 and is highly reflective to an oscillation wave (fundamental wave 18) (see FIG. 2) of the laser crystal 8. On the other end surface of the laser crystal 8, a third dielectric reflection film 29 is formed, which is highly transmissive to the fundamental wave 18 and is highly reflective to a secondary higher harmonic wave 20.

On an incident end surface of a wavelength conversion crystal 9 such as KTP, a fourth dielectric reflection film 31 is formed, which is highly transmissive to the fundamental wave 18 (see FIG. 2) and to the secondary higher harmonic wave 20. On an exit end surface of the wavelength conversion crystal 9, a second dielectric reflection film 11 is formed, which is highly reflective to the fundamental wave 18 and is highly transmissive to the secondary higher harmonic wave 20.

FIG. 2 shows the relation of the fundamental wave 18 and the secondary higher harmonic wave 20 with the first dielectric reflection film 7, the third dielectric reflection film 29, the fourth dielectric reflection film 31 and the second dielectric reflection film 11.

Except openings 32, 33 and 34 of the laser crystal 8 and the wavelength conversion crystal 9 where the excitation light 17, the fundamental wave 18 and the secondary higher harmonic wave 20 pass through, a metal or metal family film 35 is provided over the entire surface. As metal material, a metal such as Au, Cu, Al or In is selected, for instance, and it is preferable that the material of the film has high thermal conductivity.

As a method for forming the film, a method such as electrocasting, vacuum evaporation, etc. is used, which does not cause physical gap between the first dielectric reflection film 7 and the metal or metal family film 35.

The laser crystal 8 and the wavelength conversion crystal 9 are bonded together by soldering or by metal diffusion via a metal or metal family film 35a formed between the laser crystal 8 and the wavelength conversion crystal 9.

The metal or metal family film 35a formed between the laser crystal 8 and the wavelength conversion crystal 9 serves as a spacer, which keeps optically non-contact condition between the third dielectric reflection film 29 and the fourth dielectric reflection film 31. A reflectivity and a transmissivity of the third dielectric reflection film 29 and the fourth dielectric reflection film 31 can be set by regarding boundary surfaces as the air, and this facilitates the manufacture.

The optical resonator 3 is bonded with a heat radiation member 36 such as a heat sink by soldering. The metal or metal family film 35 also serves as a base film when the optical resonator 3 is soldered to the heat radiation member 36. The optical resonator 3 and the heat radiation member 36 may be bonded together by metal diffusion between the metal or metal family film 35 and the heat radiation member 36 or by metal diffusion using a film of other type of metal between the metal or metal family film 35 and the heat radiation member 36. In FIG. 1, reference numeral 37 denotes a soldering layer.

The optical resonator 3 and the heat radiation member 36 are bonded together by soldering or by metal diffusion. As a result, physically high adhesion can be attained, and this leads to high thermal conductivity between metals of the optical resonator 3 and the heat radiation member 36.

FIG. 1 shows heat transfer in the present invention. The heats generated at the laser crystal 8 and the wavelength conversion crystal 9 transfer to the metal or metal family film 35 and are radiated from the surface of the metal or metal family film 35 to the surrounding. Because the metal or metal family film 35 is a film of metal or of metal family, which has high thermal conductivity, the resistance to heat transfer from the laser crystal 8 and the wavelength conversion crystal 9 is low, and heat radiation efficiency is high. If gold is used as the material of the metal or metal family film 35, effects of heat transfer and heat radiation will be increased more.

The heat accumulated in the laser crystal 8 transfers from the incident surface of the laser crystal 8 to the metal or metal family film 35 and is radiated from the end surface or the side surface of the laser crystal 8. The heat from the exit surface of the laser crystal 8 transfers to the metal or metal family film 35a and is radiated from the side surface of the optical resonator 3. The heat from the exit surface of the laser crystal 8 transfers from the metal or metal family film 35a to the wavelength conversion crystal 9 and is radiated via the wavelength conversion crystal 9.

As described above, the heat generated at the laser crystal 8 and the wavelength conversion crystal 9 is diffused and radiated efficiently, and a temperature rise is suppressed. In particular, on the incident end surface of the first dielectric reflection film 7, the heat generated on the incident portion of the excitation light 17 can be efficiently diffused to the surrounding by the metal or metal family film 35b, and this prevents local temperature difference.

The heat radiation member 36 may be designed as a part of the optical resonator 3, and the optical resonator 3 and the heat radiation member 36 may be integrated with each other. In this case, a heat sink or a Peltier element may be mounted on the heat radiation member 36 so that the optical resonator 3 can be cooled down via the heat radiation member 36.

In the above, description has been given on the optical resonator 3 to output a secondary higher harmonic wave. The same operation and the same effects can be achieved when the optical resonator 3 is designed to output a fundamental wave or to output a third higher harmonic wave.

In the embodiment described above, the third dielectric reflection film 29 is designed to be highly reflective to the secondary higher harmonic wave 20, while it may be so designed that the fourth dielectric reflection film 31 may be changed to a reflection film similar to the third dielectric reflection film 29, and the incident surface of the wavelength conversion crystal 9 is designed to be highly reflective to the secondary higher harmonic wave 20.

Further, instead of forming the metal or metal family film 35a on the exit end surface of the laser crystal 8 and on the incident end surface of the wavelength conversion crystal 9, the laser crystal 8 may be bonded with the wavelength conversion crystal 9. In this case, the transmissivity and reflectivity of the third dielectric reflection film 29 and the fourth dielectric reflection film 31 are set with respect to the adhesive agent and the optical member.

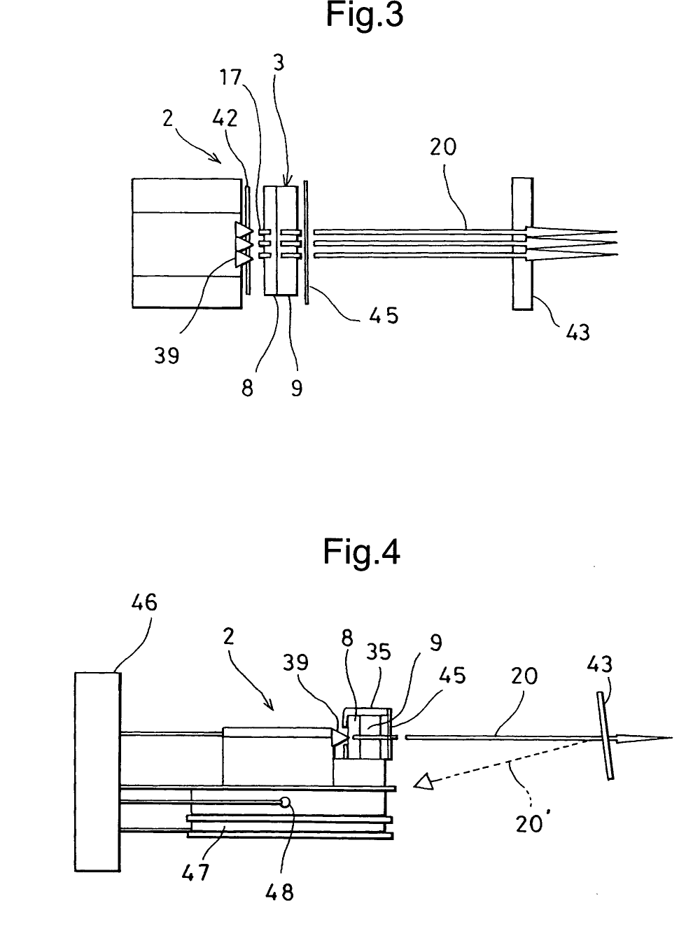

Referring to FIG. 3 to FIG. 6, description will be given below on a laser device, in which the laser oscillation device 1 described above is used.

The light emitting unit 2 is composed of a plurality of laser diodes 39. The plurality of laser diodes 39 serving as light emitting elements are arranged as linearly parallel to each other. A plurality of excitation lights 17 emitted from the laser diodes 39 pass through a fiber lens 42, and the luminous fluxes have the cross-sections adequately regulated and are emitted in parallel toward the optical resonator 3.

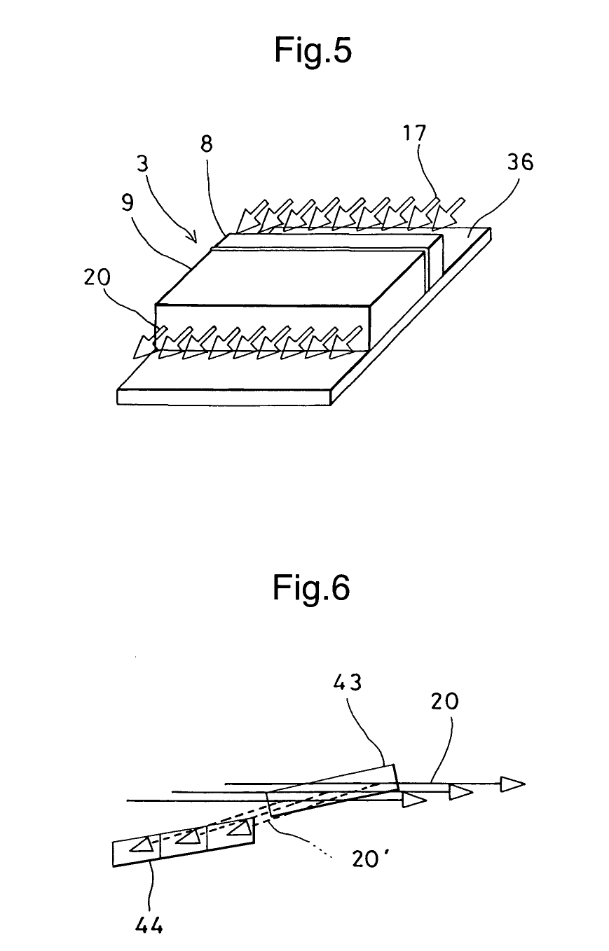

The optical resonator 3 is composed of the laser crystal 8 and the wavelength conversion crystal 9 integrated together. The optical resonator 3 is designed in shape of a rod to traverse the plurality of excitation lights 17. As shown in FIG. 5, when the plurality of excitation lights 17 parallel to each other enter the optical resonator 3, a plurality of secondary higher harmonic waves 20 to match each of the excitation lights 17 are emitted from the wavelength conversion crystal 9.

On the optical path of the secondary higher harmonic wave 20, a half-mirror 43 in form of a rectangular is arranged. A part of the plurality of the secondary higher harmonic waves 20 is reflected as monitor lights 20′ by the half-mirror 43. The monitor lights 20′ are received individually by photodetection sensors 44 arranged with the same pitch as the distance between the plurality of secondary higher harmonic waves 20. In FIG. 3, reference numeral 45 denotes a filter to cut off the wavelengths other than those of the secondary higher harmonic waves 20.

By each of the photodetection sensors 44, optical intensities of the plurality of the secondary higher harmonic waves 20 are detected individually, and the detection results are sent to a light emission control unit 46. Light emission of the laser diodes 39 is controlled by the light emission control unit 46 so that the light intensities of the plurality of the secondary higher harmonic waves 20 are kept at constant level or total light intensity of the plurality of secondary higher harmonic waves 20 is set to a certain predetermined value.

The optical resonator 3 is cooled down by a cooling means 47 such as a Peltier element via the heat radiation member 36. Also, the temperature of the heat radiation member 36 (temperature of the optical resonator 3) is detected by a temperature sensor 48. The temperature detected by the temperature sensor 48 is sent to the light emission control unit 46, and the cooling means 47 is driven so that the optical resonator 3 is maintained at a predetermined temperature.

Although not shown in the figures, the plurality of the secondary higher harmonic waves 20 emitted from the optical resonator 3 are bundled together via optical fibers and are outputted as a single laser beam with a predetermined light intensity. In the present laser device, the plurality of excitation lights 17 are emitted to the optical resonator 3 at the same time, and as many secondary higher harmonic waves 20 as the excitation lights 17 are emitted. Thus, the secondary higher harmonic waves 20 with high output can be gotten in compact and simple arrangement.

The optical resonator 3 converts a plurality of excitation lights 17 to a plurality of secondary higher harmonic waves 20, and emits the plurality of secondary higher harmonic waves 20. As a result, the amount of generated heat is high. However, the heat accumulated on the laser crystal 8 and the wavelength conversion crystal 9 is efficiently diffused via the heat radiation member 36, and temperature rise is suppressed.

What is claimed is:

1. A laser oscillation device, comprising optical crystals, wherein a metal or metal family film is formed over the entire surface of the optical crystals at least except openings where excitation lights enter.

2. A laser oscillation device according to claim 1, wherein said optical crystals comprise a laser crystal for converting an excitation light to a fundamental wave and a wavelength conversion crystal for converting a fundamental wave to a secondary higher harmonic wave, said metal or metal family film is formed on the two crystals except openings where the excitation light, the fundamental wave, and the secondary higher harmonic wave pass through, and said laser crystal and said wavelength conversion crystal are soldered together via said metal or metal family film or are bonded together by metal diffusion.

3. A laser oscillation device according to claim 1, wherein said optical crystals comprise a laser crystal for converting an excitation light to a fundamental wave and a wavelength conversion crystal for converting a fundamental wave to a secondary higher harmonic wave, said metal or metal family film is formed on the two crystals except openings where the excitation light, the fundamental wave, and the secondary higher harmonic wave pass through, and said laser crystal and said wavelength conversion crystal are bonded together by metal diffusion via said metal or metal family film.

4. A laser oscillation device according to claim 2 or 3, wherein a first dielectric reflection film is formed on an incident surface of said laser crystal and a third dielectric reflection film is formed on an exit surface of said laser crystal, a fourth dielectric reflection film is formed on an incident end surface of said wavelength conversion crystal and a second dielectric reflection film is formed on an exit surface of said wavelength conversion crystal, and said third dielectric reflection film and said fourth dielectric reflection film are kept in optically non-contact condition from each other.

5. A laser oscillation device according to claim 2 or 3, wherein said metal or metal family film is interposed between said third dielectric reflection film and said fourth dielectric reflection film, and said third dielectric reflection film and said fourth dielectric reflection film are kept in optically non-contact condition from each other.

6. A laser oscillation device according to claim 4, wherein said first dielectric reflection film is highly transmissive to the excitation light and is highly reflective to the fundamental wave, said second dielectric reflection film is highly reflective to the fundamental wave and is highly transmissive to the secondary higher harmonic wave, and one of either said third dielectric reflection film or said fourth dielectric reflection film is highly reflective to the secondary higher harmonic wave.

7. A laser oscillation device according to claim 5, wherein said first dielectric reflection film is highly transmissive to the excitation light and is highly reflective to the fundamental wave, said second dielectric reflection film is highly reflective to the fundamental wave and is highly transmissive to the secondary higher harmonic wave, and one of either said third dielectric reflection film or said fourth dielectric reflection film is highly reflective to the secondary higher harmonic wave.

8. A laser oscillation device according to claim 1, wherein said optical crystals are soldered to a heat radiation member via said metal or metal family film.

9. A laser oscillation device according to claim 1, wherein said optical crystals are bonded to a heat radiation member via said metal or metal family film by metal diffusion.
